(19) United States
(12) Patent Application Publication
(10) Pub. No.: US 2003/0217006 A1
(43) Pub. Date: Nov. 20, 2003

(54) Methods and apparatus for a title transaction network

(76) Inventors: Stefan Roever, Los Altos Hills, CA (US); Kevin Collins, Folsom, CA (US); Josh C. Ding, San Jose, CA (US); Alex F. Clark, Campbell, CA (US)

Correspondence Address: IPSG, P.C., P.O. BOX 700640, SAN JOSE, CA, 95170-0640, US

(21) Appl. No.: 10/232,861

(22) Filed: Aug. 30, 2002

Related U.S. Application Data
(60) Provisional application No. 60/380,787, filed on May 15, 2002.

(51) Int. Cl. G06F 17/60

(52) U.S. Cl. 705/50

(57) ABSTRACT

A title management apparatus is resident on a computer server and includes a memory for storing a control program and data, and a processor for executing the control program and for managing the data. The computer memory has user data resident including user security indicia. A plurality of title objects are resident in the memory, where each title object includes a content element, attributes, and security indicia. An authorization structure is configured to selectively grant access to users based at least in part of the user security indicia. A title management structure configured to associate a user with particular title objects based at least in part of the user data and the title attributes, and the title management structure is configured to support the exchange of title objects between users. Advantages of the invention include the ability to manage titles over a network such as the Internet.

### REFERENCE TO RELATED APPLICATIONS

This application claims the benefit of U.S. Provisional Application No. 60/380,787, filed May 15, 2002.

### FIELD

The invention relates to an advanced title and transaction network. In particular, the invention provides an architecture and operation for the facilitation of the creation, ownership, exchange, management, reselling, marketing, bartering, and auctioning of titles over an electronic network such as the Internet.

### BACKGROUND

The Internet has become an efficient mechanism for globally distributing digital content, such as documents, pictures, music, and other types of digital content. Information can now be transmitted directly and instantly across the Internet from the content owner to the content buyer, without having to first convert it into physical form, such as paper documents, compact disks, photographs, etc.

However, the advantage of easy digital communication has also allowed digital content to be easily pirated by just about anyone with a computer and Internet access. The combination of high-speed broadband Internet access, digital content compression software (which reduces the size of digital content files), peer-to-peer file trading networks (which allows users to post content files), and lack of a viable digital rights standard, has caused the content owners to lose control of their content. Consequently, content owners are experiencing a loss of potential revenue.

The lack of a standardized and transparent digital rights management system, however, is preventing a commercially viable solution from emerging. In order for such a system to be commercially viable, the system should be secure both from the user's and the content owner's standpoint, universal so that electronic device manufactures are encouraged to engineer it into their products, and transparent so that users are not required to change their behavior.

Existing systems that attempt to provide confidence between buyers and sellers include escrow agreements, third party confirmations, third party appraisals and other similar techniques. These systems are slow and complex, and they do not provide the content user with sufficient confidence that the buyers and sellers are not illegally replicating the content or otherwise attempting to sell pirated copies of works.

In addition to the pirating aspects associated with sharing digital content, users are burdened with less than ideal methods for legally sharing digital content. These cumbersome methods include transferring entire files to other users via electronic mail, instant messenger, peer-to-peer and other applications, or sharing hyperlinks via electronic mail, instant messenger, and other applications. These methods can be viewed as counter productive, anti-social and even bothersome to the users that receive or attempt to share the content. Sharing of entire digital content such as music via electronic mail is a drain on resources and inefficient to the electronic mail servers, the network, and the receiving users. Sharing of hyperlinks can lead to broken links, complex URL (Universal Resource Locator) strings, and restrictions on the type of content that can be shared (i.e. linked to). Compatibility problems are widespread and create frustration when sharing digital content of a specific media type.

What is needed are advanced techniques for controlling the trading of digital rights so that the buyers are assured of an authentic copy, “fair use” is preserved for the copy, and content owners are fairly compensated. In addition, advanced techniques are employed to provide an easy, friendly, efficient, and adaptable method for users to share digital content.

### SUMMARY

The invention relates to an advanced title transaction network. In particular, the invention provides an architecture and operation for the facilitation of the creation, ownership, exchange, management, reselling, marketing, bartering, and auctioning of titles over an electronic network such as the Internet. A title is defined as an object that conveys evidence of the rights that an owner has to some content or to use some resource. The title also describes and defines the content or resource to which rights have been expressed.

An exemplary embodiment a title management apparatus is resident on a first computer including memory for storing a control program and data, and a processor for executing the control program and for managing said data. The title management apparatus comprises user data resident in memory including user security indicia, one or more title objects resident in said memory, where each title object includes a content element, attributes, and security indicia. The title management apparatus also comprises an authorization structure configured to selectively redeem the content element based at least in part of the user security indicia, and a title management structure configured to associate a first user with particular title objects based at least in part of the user data and the title attributes.

In another aspect of the invention, the title object is one of a tag, a ticket, and a token.

In another aspect of the invention, the content element is a pointer that is indicative of a digital content file address. The title management apparatus further comprises a content storage structure including a first storage element for storing a first digital content file, and a title publishing structure including a second storage element for storing the title object. The title management structure is configured to redeem the title object from the title publishing structure, and the title management structure is further configured to redeem the first digital content file that is indicated by the pointer.

In another aspect of the invention, the content storage structure is resident on a second computer that is communicably connected to the first computer.

In another aspect of the invention, the title publishing structure is resident on a third computer that is communicably connected to the first computer and the second computer.

In another aspect of the invention, the first digital content file is a compilation of one or more additional digital content files.

In another aspect of the invention, the first digital content file is a compilation of one or more title objects.

In another aspect of the invention, the first digital content file is a compilation of at least one additional digital content file and at least one title object.

In another aspect of the invention, security indicia include an authorization of a second user.

In another aspect of the invention, a transaction maker structure is configured to store title objects, offered for one of sale and exchange, by one or more users. The transaction maker structure is configured to transfer title ownership from a first user to a second user.

In another aspect of the invention, the title management structure is configured to notify said second user of a sale or exchange.

In another aspect of the invention, the title management structure is configured to require an acceptance by said second user.

In another aspect of the invention, the title management structure is configured to allow the second user to propose a counter-offer.

In another aspect of the invention, the memory includes a chained hash control program. The title management structure is configured to execute the chained hash control program when the title object is transferred between a first user and a second user thereby creating a new security indicia, and to modify the title object security indicia to store the new security indicia.

In another aspect of the invention, a lock box structure is configured to store the title object during the transfer.

Advantages of the invention include the ability to manage and share titles over a network such as the Internet. Additional advantages of the invention include creating a system whereby digital content providers can offload the burden of managing and enforcing user access rights, yet receive revenue from third party transactions. The user benefits by having a facility to easily manage and share all of their digital content and resources which they might have access to over a network. As an entire system, the benefits can be realized by all parties involved, and additional value-add can be created, marketed, sold, and shared throughout the system.

### BRIEF DESCRIPTION OF THE DRAWINGS

The invention is described with reference to the figures, in which:

FIGS. 1A-B depict a computer network and a title management apparatus according to an embodiment of the invention;

FIGS. 2A-B depict a computer network and a title management apparatus according to an embodiment of the invention;

FIG. 3 depicts a computer network and a title management apparatus according to an embodiment of the invention;

FIG. 4 depicts exemplary user data according to an embodiment of the invention;

FIG. 5 depicts exemplary title data according to an embodiment of the invention;

FIG. 6 depicts a logical structure of the invention according to an embodiment of the invention;

FIG. 7 depicts a logical structure of the invention as deployed in a system according to an embodiment of the invention;

FIGS. 8A-E depict exemplary title management displays according to an embodiment of the invention;

FIGS. 9A-B depict exemplary title creation and editing displays according to an embodiment of the invention;

FIGS. 10A-B depict exemplary administrative user control displays according to an embodiment of the invention; and

FIG. 11 is a flow chart showing steps for performing a title transfer according to an embodiment of the invention.

### DETAILED DESCRIPTION

The invention is directed to the creation, ownership, exchange, management, reselling, marketing, bartering, and auctioning of titles.

In this context, a title is an object that may have a number of elements and attributes including embedded digital content, ownership attributes, copy permissions, and others as described herein. A title can also represent the rights to a single piece of digital content or a single resource, or it can represent the rights to a multitude of digital content and resources and in a variety of formats. The digital content rights, such as the ability to exchange or copy, are determined by the content publisher. Furthermore, a title can also represent the rights to another title or multitude of titles, which in turn express rights to digital content or resources.

Users can initiate a variety of exchanges with each other depending on the type of title and the rules associated with that title. These exchanges can take the form of trades, transfers, or copies. In the case of trades, offers can be reviewed, and then subsequently accepted, canceled, or a counter-offer can be presented. The counter-offer process can continue until satisfaction, or until trade is canceled. In the case of transfers, the ownership of the titles is transferred from one owner to another without the need for another title to be traded in kind. In the case of copies, a title is simply copied from person to person. Trades, transfers, and copies are subject to the type and rules associated with the title(s) involved in the transaction.

The title management and title publisher apparatus can also be used to create anonymous titles. These titles are useful for individuals that want to conduct anonymous transactions, in that their specific identities are not known to the other party. Anonymous titles can be used to provide secure, anonymous, links to the parties involved and only the resolver and title management apparatus will be able to specifically identify the party on their end of the transaction.

Internally, the title transaction system utilizes titles for inter-process communication and to relay security indicia between components. For example, a trade transaction between two parties that are each utilizing their own title management apparatus on separate computers, will involve titles in order to identify both parties. The titles used to identify both parties are in addition to the titles being traded.

In order to help protect the integrity of the trade, a chained hash cryptographic technique is used to guarantee that only a single instance of the title is in circulation at any one point in time. The title management and publisher structure performs verification on the chained hash to ensure the validity of titles. The chained hash technique is implemented in such a way as to provide benefits typically associated with one-time password and digital cash systems. However this implementation can be modified to provide a high degree of integrity around the use of titles within the system.

The chained hash technique can be combined with additional controls that work in conjunction with the rules and security classification elements to provide varying degrees of security for the title and the digital content referred to by the title. These additional controls will include cryptographic key-splitting techniques as well as multi-user and multi-factor authentication. As an example, a multi-user authentication requirement can be used for parental controls, whereby a guardian must also provide authentication (and acceptance) on the purchase and use of a title where a minor is involved. The content rating system can be used by publishers to determine appropriate ratings for their content, and these ratings can be enforced by title management and resolver apparatus to ensure guardian approval.

The exchange structure, specification, and rules provide the ability for the title publisher and/or the title owner to determine the exchange capabilities of subsequent owners of the title. For example, a title publisher could limit a title owner to only one trade, or even to deny trades but allow transfers. A title owner may transfer the title to another person for a limited period of time and deny that person any ability to trade or transfer. This ability to set limitations operates in conjunction with the rules structure.

A trust structure is also implemented to provide users with a simple ability to validate the digital content they receive. The trust structure will convey that the digital content was (if applicable) rightfully issued by the content publisher. Content publishers are not bound to use the trust structure for the titles they issue but in doing so can provide assurances to the buyer.

The invention is described with reference to specific apparatus and embodiments. Those skilled in the art will recognize that the description is for illustration and to provide the best mode of practicing the invention. For example, references are made to computer servers and clients, but in a peer-to-peer network, any computer is capable of acting in either role. Likewise, reference is made to standard Internet protocols while any substantially comparable data transmission protocol can be used.

A. Architecture

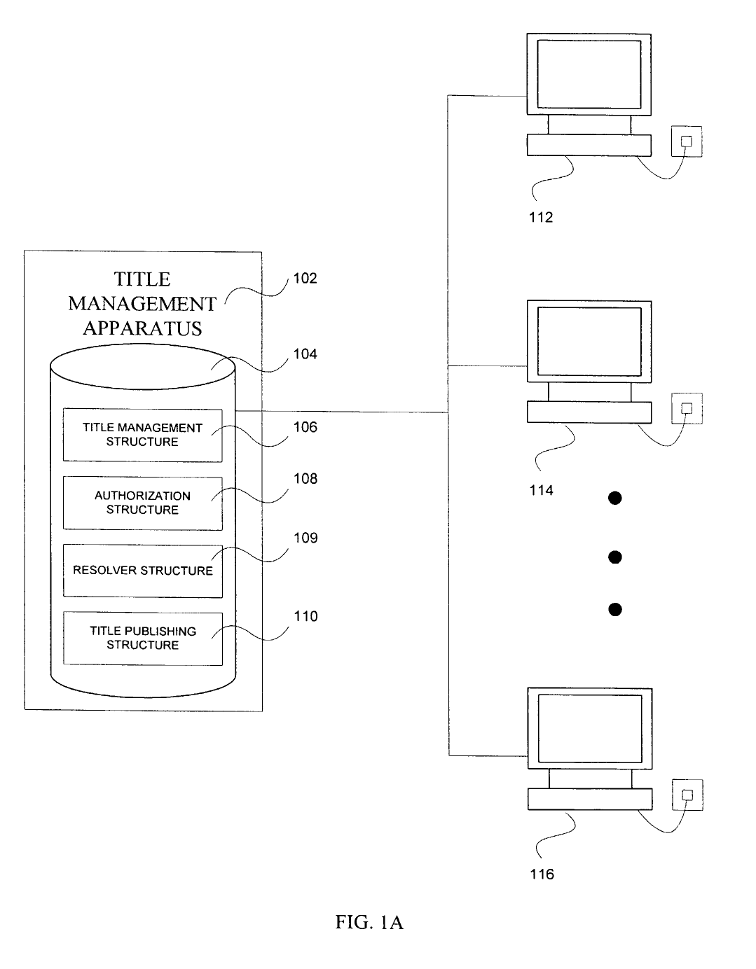

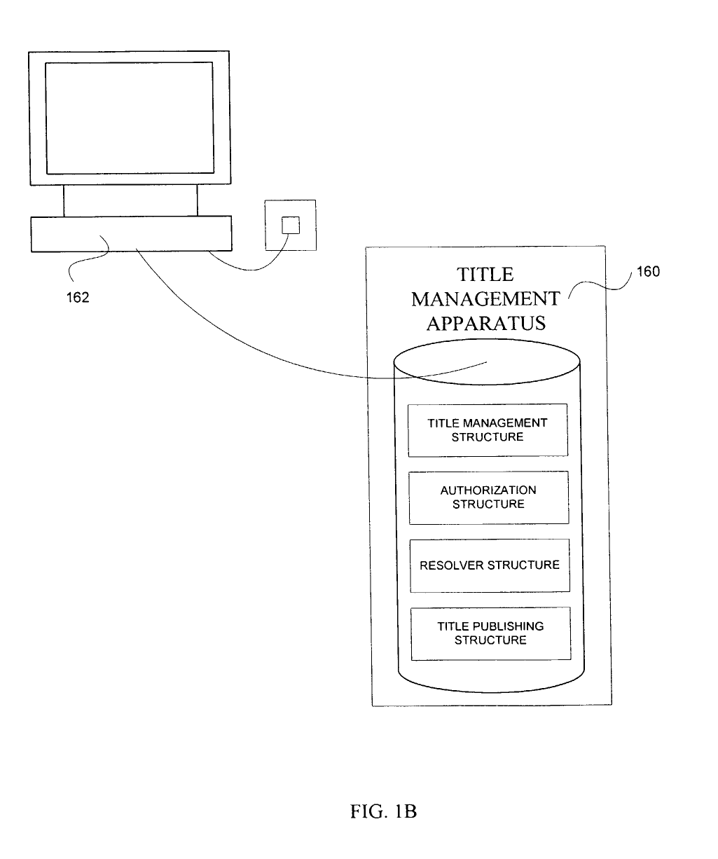

FIGS. 1A-1B depict a computer network and a title management apparatus according to an embodiment of the invention. In one embodiment, FIG. 1A depicts a title management apparatus 102 resident on a computer 104, comprising a title management structure 106, an authorization structure 108, a resolver structure 109, a title publishing structure 10 and a number of client computers 112-116 all coupled over a network (e.g. the Internet), where each of the computers 112-116 may be owned by users of the system.

The users log on to title management apparatus 102 over the network and are authorized to perform certain functions and access certain data based on their ownerships and permissions, in order to manage, resell, market, barter or auction their respective titles. A digital content file stored within a title publishing structure 110 is redeemed through a pointer stored within is respective title. This pointer indicates the location of the digital content file. However, since this location could have changed since the title was created, a resolver structure 109 substitutes the updated digital content file address, if needed.

Redemption can occur in various ways. For example, the digital content file could be downloaded in its entirety, or it could be streamed to one of the client computers 112-116 and then viewed or listened locally. If the digital content file is already stored locally, redemption could allow access or playability. In the case of an online game or chat application, redemption of the title could authorize participation.

The title system provides a layer of abstraction between the content publisher and the consumers of the content, thereby allowing the content publisher and consumer to select the best method for redeeming and obtaining the content. This decision occurs at the time of redemption rather than at the time of publishing (thereby assuming that one content format will fit all situations).

FIG. 1B depicts another embodiment in which the title management apparatus 160 is resident on a client computer 162. A user can log on to title management apparatus 160 directly without network access. As in FIG. 1, the user is authorized to perform certain functions and access certain data based on their ownerships and permissions, in order to manage their respective titles. In this embodiment, redemption of a digital content file only occurs within the memory of client computer 162.

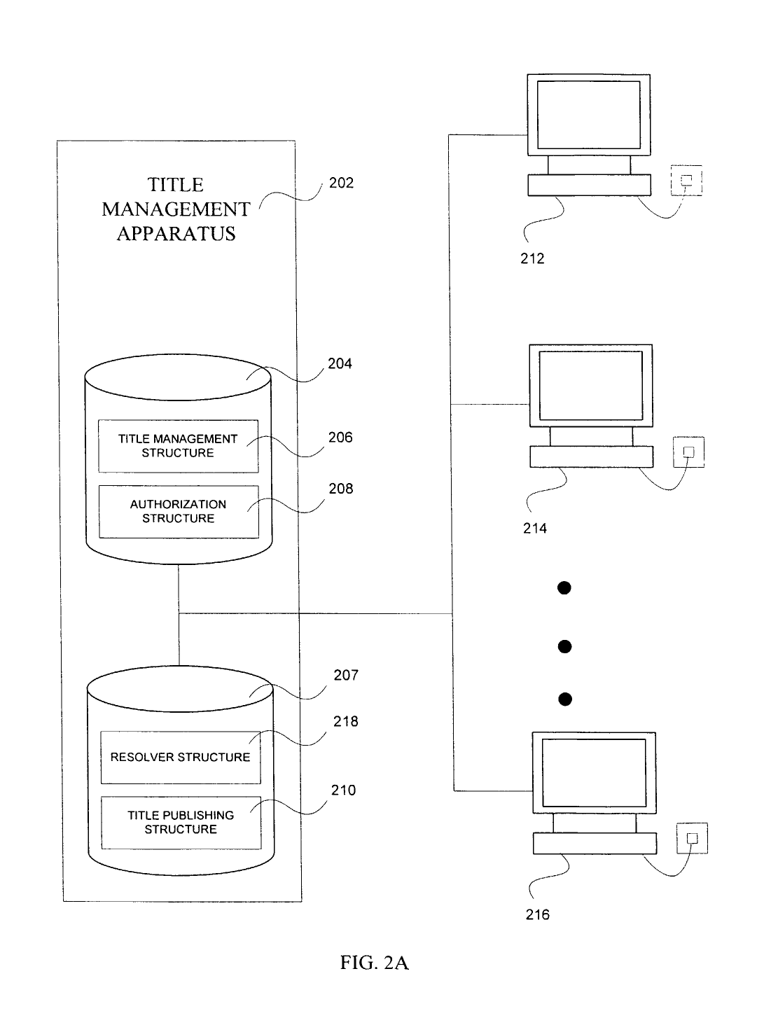

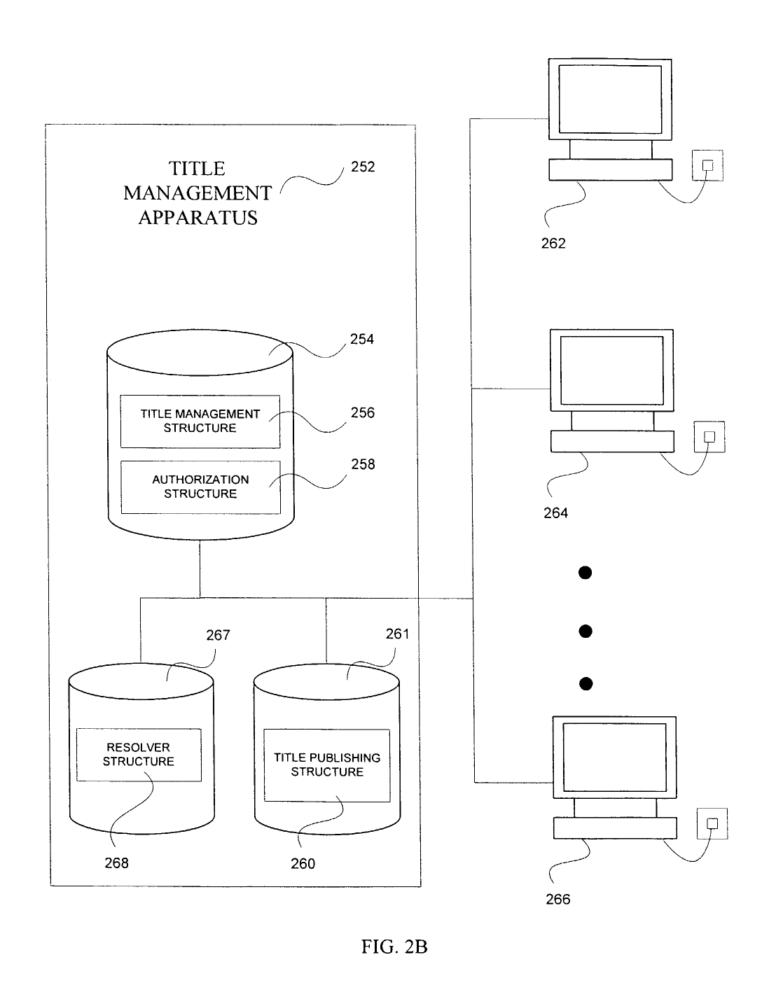

In another embodiment, FIG. 2A depicts a title management apparatus 202, wherein a title management structure 206 and an authorization structure 208 are resident on computer 204, while the title publishing structure 210 and a resolver structure 218 are resident on computer 207. Both computer 204 and computer 207 are coupled over a network to computers 212-216, which may be owned by users of the system. As in FIG. 1A, the users log on to title management apparatus 202 over the network and are authorized to perform certain functions and access certain data based on their ownerships and permissions, in order to manage, resell, market, barter or auction their respective titles.

In another embodiment, FIG. 2B depicts a title management apparatus 252, wherein a title management structure 256 and an authorization structure 258 are resident on computer 254, while the resolver structure 268 is resident on computer 267, and the title publishing structure 260 is resident on computer 261. Computers 254, 267, and 261 are coupled over a network to computers 262-266, which may be owned by users of the system. As in FIG. 1A, the users log on to title management apparatus 252 over the network and are authorized to perform certain functions and access certain data based on their ownerships and permissions, in order to manage, resell, market, barter or auction their respective titles.

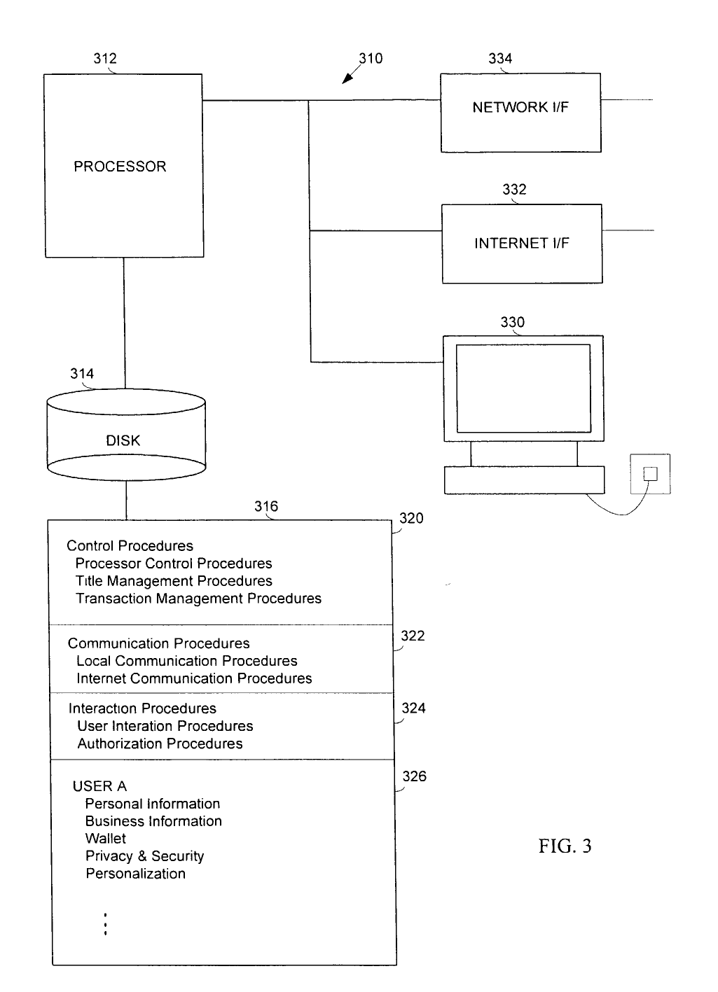

FIG. 3 depicts the computer 310 for performing the invention according to an embodiment of the invention. The computer includes a processor 312 coupled to a memory 314. The memory contains a data structure 316 further comprising a plurality of software structures including control procedures 320, communication procedures 322, interaction procedures 324 and data 326. The processor is further coupled to a user interface 330, an Internet communication interface 332 and a network interface 334.

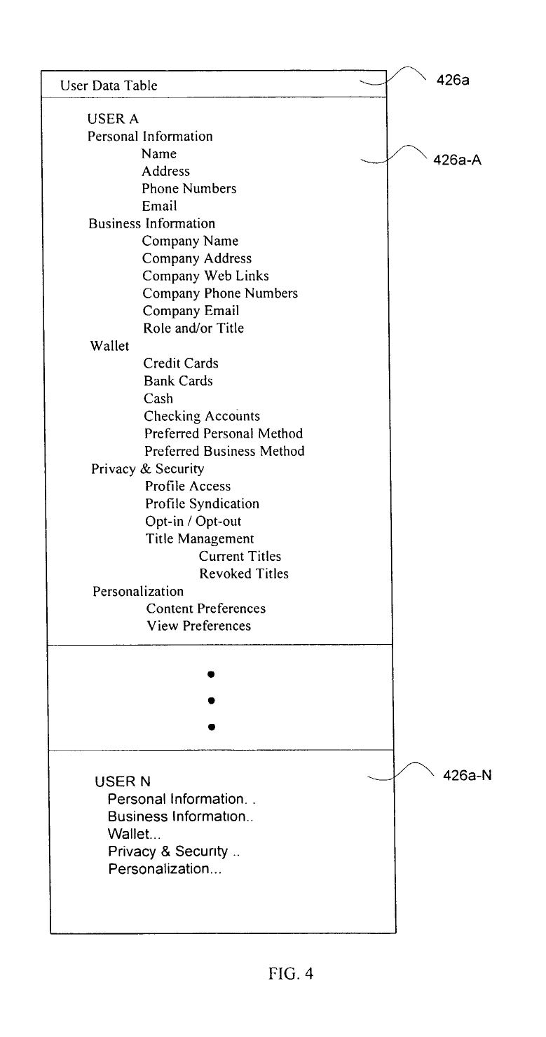

FIG. 4 depicts exemplary user data 426a according to an embodiment of the invention. The user data has a number of elements for each user 426a-A to 426a-N, including personal information fields, business information fields, wallet fields, privacy and security fields, and personalization fields. The personalization fields can be set by the user for controlling the user environment, for example, the default color scheme for the graphical user interface, the type of interface skin, and the background image. Profile information maintained on the user can include, for example, the financial information, emergency contact, medical information, and work related information. The user data and profiler are extensible to support the needs of the title transaction system.

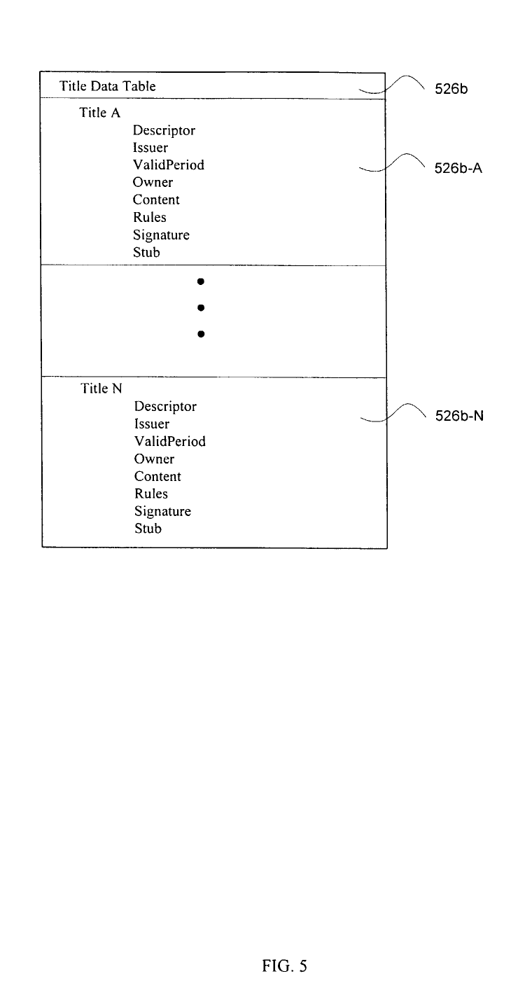

FIG. 5 depicts exemplary title data 526b for a title object. The title data has a number of fields for each title including descriptor fields, issuer fields, validity period fields, owner fields, content fields, rules fields, and signature fields. The title object can be a type such as a tag, token or ticket.

As depicted in FIG. 5, the title object has at least one content field to describe the content to which rights have been expressed. The content field may even contain the content as an embedded object. The title object may have more than one content field in order to associates the rights with multiple pieces of content or resources.

As depicted in FIG. 5, the title object has a rules field to express fine-grained rules associated with the title and the rights that have been expressed. The rules will contain logic that must be executed by participating systems in the system. Rules are extensible and can be used to provide additional controls over the processing and handling of titles. The rules field within a title object can explicitly define rules as well as reference rules stored elsewhere (either locally or remotely).

The title object has at least one stub object associated with it in order to verify the integrity and valid instance of the title. In addition to identifiers, the stub object will contain security indicia, such as the indicia required by the chained hash technique, in order to validate the single instance and valid ownership of the title. This stub object will change state on every redemption, exchange, and revocation of the title.

The title object may have more than one stub object associated with it in order to convey additional information, controls, content, or other value-add not explicitly given in the original title. The stub object provides extensibility to the title without requiring a complete replacement to the title object. As an example, a value-add reseller such as a retail merchant may attach additional content or value to the original title in order to promote their product or even to make the original title more attractive for sale or trade. In another example, an additional control stub maybe attached to the original title in order to ensure appropriate handling of the title for use by minors, such as ensuring that only an edited version of the content is viewed. The use of the stub object is flexible to ensure extensibility of the title object.

As depicted in FIG. 5, the stub object can contain a digital signature element in order to verify the integrity of the stub. Although the stub is viewed as an extension to the title, the stub can be digitally signed by any participant in the system. This permits a flexible architecture where multiple participants can collaborate on adding value to a title object.

The system employs a set of specification and rules for structuring, creating, managing, handling and using titles. The specification and rules, as well as the format of the title, are extensible to support the needs of both the user and content publisher, as well as the needs of intermediary systems within the system that handle (or interact) with titles.

In the exemplary embodiment, a tag is a title object that can be copied among users, a token is a title object that cannot be copied like a tag, but can be transferred or exchanged between users, and a ticket is a title object that is issued to a specific user, and hence cannot be copied or transferred among users.

B. Logical Structure and Operation

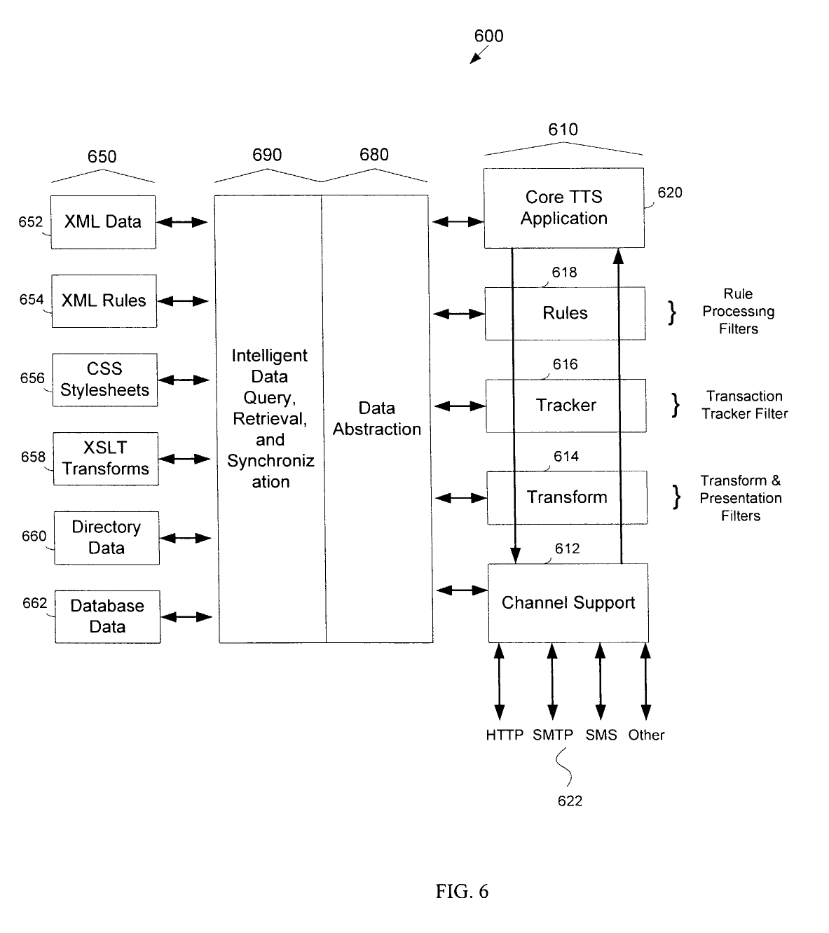

FIG. 6 depicts a logical structure 600 of the invention according to an embodiment of the invention. The primary parts of the logical structure are the processing portion 610, the data portion 650, the intelligent data query, retrieval, and synchronization portion (IDRQS) 690, and the data abstraction portion 680. As shown, the processing portion 610 communicates with the data portion 650, first through the data abstraction portion 680, and then through the IDRQS 690 portion. FIG. 6 represents the primary model for implementation and deployment of the title transaction system, however the design is intended to be modular in that components can be eliminated or modified as required by the environment and requirements. For example, this model maybe modified to permit operation of certain TTS components within a limited resource computing device such as a mobile phone. In another example, a fixed implementation may eliminate certain abstractions when knowingly operating in a static environment with a limited set of titles.

A channel support structure 612 is responsible for communicating with users and is associated with the communication protocols 622. The channel support 612 communicates over the network using a number of possible protocols including HTTP (hyper-text transfer protocol), SMTP (simple mail transfer protocol), SMS (short messaging service) and others.

The title protocol will define a standard set of protocol bindings to describe how title transactions are communicated across those protocols. However the title protocol specification will define extensions so that the title protocol can be bound to other [underlying] protocols as required within the system. When an inbound message is received by the channel support, the message is passed along to a number of other structures that decode, transform and interact with the message.

For example, a transform structure 614 performs a transform on the inbound data request to conform it to a normalized application interface for a core title transaction application. The use of the transform layer at this point provides standardized parsing of the transaction as it proceeds through the pipeline to the core title transaction application. In addition, the transform structure will perform various transformations on the outgoing response to conform it to a normalized response for the calling application.

A tracker structure 616 performs a transaction tracking filter to maintain a log of all the inbound messages and requests. The tracker structure will log the incoming request as well as the outgoing response.

A rule structure 618 then applies a number of possible rules to the message. The rule structure obtains its rule sets from several sources including the title itself (as defined in the title format), data storage through the data abstraction portion, and extensions that can support the retrieval of rules through other sources such as via the network. The rules include characteristics for each title, for example, whether it can be refunded, exchanged, played viewed, etc. Often, the functions that can be performed on a given title are related to the title type. For example, in the exemplary embodiment, titles of type tag can be freely distributed to all users, titles of type ticket are tied to a specific user and cannot be exchanged, and titles of type token can be exchanged with other users. When a title of type token is exchanged with another user, the user can no longer redeem that title, and the system may disable any offline content associated with the title.

For instance, the content element within a title can contain an encrypted password that is not known to the user. A program for viewing or playing the offline content, such as Windows Media Player, would read the title through a application program interface, check the rule sets, and then execute content, such as an MP3 file, using the encrypted password. Once a user exchanges the title with another user, the rule sets would be modified to reflect that that the user no longer has rights to the content, and the content itself could not be played or viewed.

The rules associated to the title are developed and applied by the content publisher and by the user (or someone acting on behalf of the user). The title management and title publisher modules provide an application and interface to easily develop and apply rules to the titles. For example, a content publisher can apply usage rules applicable to the title and the digital content and/or resource it provides evidence of rights to. In turn, a user may apply default rules within the title management module to assist in controlling and protecting their actions related to certain titles (for example, to prevent from accidentally trading a valuable title). In another example, a parent may establish restrictions on the type of content their child may access and use in their title management module.

Specialized rules, such as triggers and timers, may also be used. Triggers are rules that invoke actions that are external to the title management apparatus. For instance, a parent can be notified by email that a child wishes to redeem a digital content file for which there is some age restriction.. Timers are rules that invoke actions based on a specific time or based on a spent amount of time. For example a title may only be good for twenty four hours, or an exchange may only be valid for one week. Timers maybe combined with triggers in rule processing.

The core title transaction application 620 (Core TTS) is the application that verifies the ownership of the titles by the users and that authenticates the titles and selectively permits the titles to be transferred if such rights are allowed. Among the modules contained within the Core TTS application are the following.

(a) A title manager module performs management functions on titles such as organizing, deleting, adding, transferring, trading, copying, backing up, viewing, and redeeming. In addition to basic title functionality, the title manager module can provide sophisticated and value-add features to allow the user a better online experience such as chat where real-time redemption and trading are available during the chat session. Furthermore, features such as sorting categorizing, searching and notify can be made available to the user. As an example, a sophisticated search capability can be implemented whereby the user can search the network for other users, titles available for bid, transaction makers, or even a secure and trusted third party lockbox with which to conduct a trade. This sophisticated discovery process will be an integral part of the TTS system. The title manager module is the primary application component that the user will interact with on a regular basis. The title manager module maybe designed to be a single-user or multi-user application depending on the specific use of the module. A single-user version can be used in a peer-to-peer network, whereas a multi-user version can be deployed with consumer aggregators. The title manager implements a lockbox feature that is responsible for securely executing trades between two parties. The lockbox provides storage for titles being traded and provides a secure environment where users can verify trades, view samples, and accept a trade. Upon acceptance of the trade by all parties involved, the lockbox will execute the trade and provide each party with an updated title and stub object-pair that evidences their new rights. The lockbox feature of the title manager can be implemented as a standalone service so that a trusted third party can provide secure execution of trades.

(b) A transaction tracker module performs the basic task of tracking all inbound and outbound transactions whether successful or not. The tracker module is configurable by the user to determine the level of tracking to be performed based on the user's requirements. The tracker will be used to provide a record of all transactions performed by the user such as trades and transfers. The tracker will be used by all Core TTS components for creating a record of all transactions (for example, those performed by the resolver and content publisher). The tracker will record transactions in a data repository using the data abstraction portion.

(c) A rules builder module performs the task of building rules to be associated with the titles and processing of the titles. The rules builder module will provide an easy to use interface for the user to create and build rules that can be embedded within a title or used during the processing of a title. Rules that are not embedded within a title will be stored in a data repository using the data abstraction portion. The rules builder will provide an extension capability to apply rules developed external to the rules builder ensuring the adaptability of title processing.

(d) A title resolver module that performs the important task of resolving all titles presented. This process involves all applicable tasks [to the title presented] including verifying integrity of the title, validating the title, ensuring ownership of the title, decoding and decrypting the necessary title elements and retrieving the content or resource requested. The title resolver will be responsible for executing and acting upon rules and triggers that are applicable to the title presented. An additional function of the resolver would be to refresh old titles. For example, if information contained within a title became outdated, this information could be automatically refreshed either by replacing the title completely or by adding a new stub object that updates the information. In addition, the title resolver will invoke additional processes as required during operations such as the content*handler and CODEC modules.

(e) A state server module that maintains and verifies state associated with the use of titles throughout the system. The state server will work in conjunction with the title resolver in order to verify the validity of the title and generate new stub objects associated with the title on every redemption and exchange. The state server will be a high-capacity, high-availability, and high-performance system that can be widely distributed and chained in order to perform fast validation for titles in use. The State Server will perform functions and algorithms associated with the chained hash, one-time password, and key-splitting techniques.

(f) A title publisher module performs the tasks associated with publishing (that is, creating new titles). The title publisher provides an easy to use interface for a user to identify, organize, and group new content (or resources), and then generate a new title or title template that points to that digital content or those resources. Titles can be generated on the fly and immediately by the title publisher which would then invoke the title manager to store the newly generated titles. Alternatively, the title publisher can generate new title templates that would describe the contents of the title but would not immediately generate a title. Title templates could be used in a variety of ways by the content publisher, for example by the content publisher's online shopping site to automatically generate titles when a buyer purchases new content. The content publisher stores work in progress (such as grouped publishing efforts) in a data repository using the data abstraction portion. Title publishers may provide sophisticated functionality to enhance the online experience for content publishers such as organizing content and title publishing into projects, sharing projects, and allowing community projects. Workgroup and workflow capabilities can be built into the title publisher as well as creating single-user and multi-user versions. As an example, a multi-user version can be implemented by a consumer aggregator or service provider in order to perform title publishing activities on behalf of a user community. Enhanced features will provide additional value to people using the title publisher such as verifying pointers to content files and resources, automatically obtaining icons, and even pushing titles and content out to servers.

(g) A rating system module performs rating tasks on transaction records to support billing requirements. The rating system will be flexible to support the variety of billing options required within the system. The rating system will act on transaction data but will maintain separation between the data sets to ensure integrity of the transaction log.

(h) A CODEC module performs coding and decoding functions on the content retrieved by the title resolver. The primary purpose of this module is to encapsulate content in a secure package as determined by the security required of the title and established by the rules. For example, this module can perform digital watermarking of music and image content, and it can also be used to encrypt the content in a traditional digital rights management package. Additionally, the CODEC can be used by the resolver to decode contents within the title before processing by the resolver. The CODEC will provide mechanisms to support these functions as required within the system.

(i) A billing interface module provides an interface to the billing system operated by the user [or entity] running any of the Core TTS modules.

(j) A transaction viewer module provides an interface for the user to view transactions recorded by the transaction tracker.

(k) A content handler module performs the tasks associated with retrieving the content. This module will generally be invoked by the resolver. The content interface module will be extensible to support a variety of content and resource systems in use by content publishers. Content handlers provide high-performance, highly distributed, and flexible handling of content on behalf of the resolver. Multiple content handlers can be operated simultaneously, each working on behalf of a single or multiple resolvers. Content handlers provide gateway and/or proxy functions for securely passing content through to the client

(l) A synch & replication module performs synchronization and replication across components and modules within the TTS system. This is required for a number of functions including (but not limited to) synchronization and replication of transaction log entries, synchronization of titles across title management modules in a highly distributed environment, and replication of title databases to support redundancy and high-availability. The synchronization and replication process will be a tightly integrated and primary process for the intelligent data retrieval, query and synchronization module.

(m) A crypto interface module performs symmetric and asymmetric cryptographic functions as required within the TTS system.

(n) An authentication and authorization module performs the type authentication and authorization required by (and specified by) the title or other system configurations. Authentication may not be required in certain instances, or can be as simple as providing an identifier for “free” use. Strong authentication may be required for other instances and will be enforced by the system components. Strong authentication can take the form of two-factor such as Smartcard and PIN, or via mobile phone using a SIM card and a PIN, or via any other supported method such as a SecurID token card. In basic form, authentication will be a username and password. Authorization will provide fine-grained access control to Core TTS applications as well as to use titles within the system. Authorization will be based on rules established within titles and configured as part of the implementation of Core TTS applications.

(o) Payment and wallet interface modules provide both back-end and front-end interfaces to handle payment on behalf of a user or entity operating the Core TTS components. This permits real-time and batch processing of payment requests as configured by the user or entity. It also provides a friendly interface for users of the Wallet system to handle payment functions such as selecting payment type, viewing sales orders, and creating payment slips. The wallet module will provide extensible functionality to support a variety of payment types such as credit card, debit card, checking, digital cash, additional credit instruments, additional cash instruments, and other applicable payment instruments.

(p) A cache management module performs basic caching functions of the content or resources retrieved by the title system. This function will provide performance benefits using cached content versus retrieving new content on every request for the same content.

(q) A user registration module performs registration of new users into the Core TTS components and modules. This will be used to establish new users in a single user environment such as peer-to-peer, as well as establish new users in a multi-user environment such as that hosted by a consumer aggregator (where the consumer aggregator is an entity that operates the Core TTS modules on behalf of their customers).

(r) A transaction maker module performs transaction maker functions such as operating an exchange for the sale of titles, perform licensing of content represented by the titles, maintaining a book of trades, closing and clearing trade transactions, and performing additional value add as determined by the market.

(s) An intelligent data retrieval, query and synchronization module (IDRQS) 690 integrated with the data abstraction portion in order to perform intelligent searches and queries on a variety of data in a variety of disparate locations. The IDRQS module can combine, map, and match data before presenting it to requesting applications through the data abstraction portion. Persistence and caching can be developed into the IDRQS module to enhance performance on multiple and frequent queries/searches.

(t) A web crawler module performs searches on the web to catalog content and provide a mechanism to automatically generate titles that represent the content that has been discovered. The web crawler module can be used statically or dynamically executed based on configuration of the implementation and/or on inbound requests. The web crawler module could interface with the intelligent data retrieval and query system attached to the data abstraction layer for intelligent searches and retrieval of web content.

(u) A bot (or agent) component and structure that utilizes titles to automate functions and commands. The bot technology will incorporate logic and operate on both local and remote systems to execute pre-determined, collected, calculated, or formulated commands. For example, the bot can be used to indicate trade requirements to potential partners and automate the fulfillment process if the trade requirements are met. Command bots can also be used as an integral part of a flexible design pattern in order to relay instructions/commands to other components involved in the system. In this manner, components can be designed and implemented with very little logic with the intention that command bots, when they are received, will deliver the logic. Furthermore, components can be designed and implemented with very specific logic to satisfy a specific requirement, yet provide flexibility by additionally allowing instructions/commands to be relayed via command bots. The bot technology as implemented by titles provides a very efficient, secure, and trustworthy mechanism for automating functions. The bot technology and components will be used as an integral part of the web crawler.

(v) A discovery mechanism that can be used by all appropriate modules for discovering TTS resources that may be available on the network. The discovery mechanism ensures all TTS modules to participate in a peer-to-peer environment as well as collaborate on activities. The discovery process can ensure that trusted third parties are available for conducting secure transactions and well as simplifying the user and content publisher experience for clearing titles through the system.

In the outbound stream from the Core TTS, the rules structure 618 then performs certain functions on the outbound information according to rules stored in the data 650 and/or embedded in the title. The tracker 616 checks to ensure that the outbound information matches the inbound requests so that no inbound messages are dropped or ignored and that outbound message are responding to legitimate inbound messages. The tracker will log transactions in accordance with the configuration. The transform 614 converts the outbound information from a normalized format into a format that conforms to a user profile or preference, as well as based on incoming requests for particular transforms. For example, the data can be transformed into WML for display on a WAP enabled phone, or into HTML for display on a web browser. Certain transforms can be executed based on rules established within the system. The profile or preference data as well as the transform templates are retrieved from the data portion 650 in order to perform the transform. Finally, the channel support 612 communicates with the user of the network in a native protocol format.

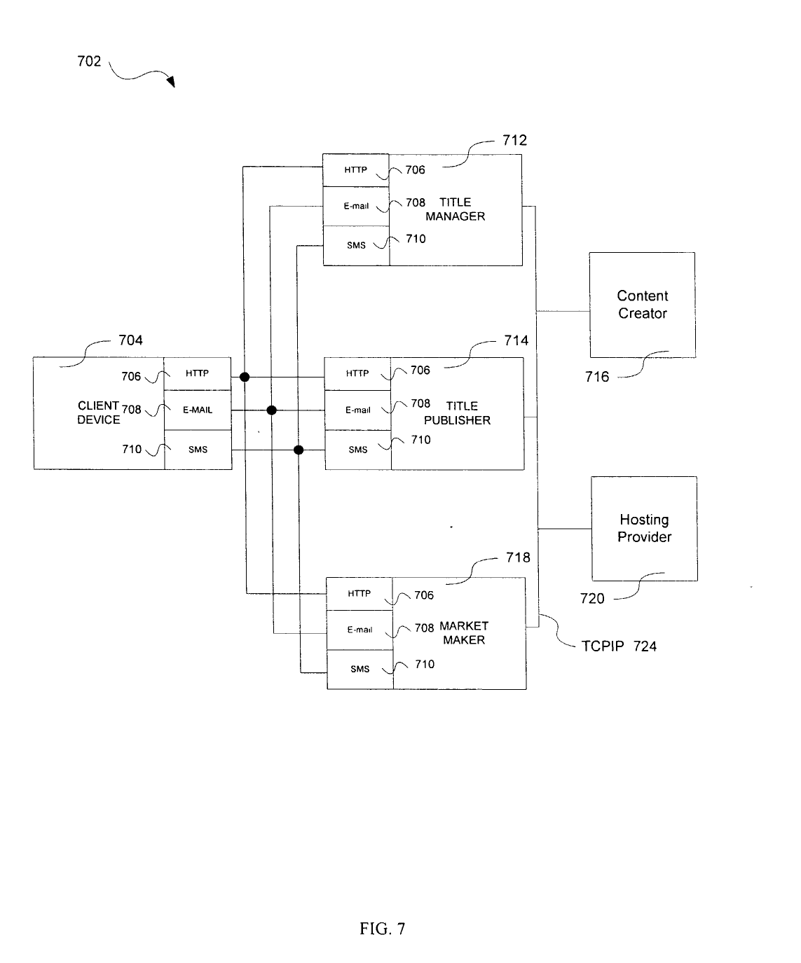

In another embodiment, FIG. 7 depicts a logical structure of the invention as deployed in a system according to an embodiment of the invention. The system 702 is comprised of a number of entities, each providing a service of benefit to the overall system, and each connected to the other using some type of network protocol.

The title manager 712, title publisher 714, transaction maker 718, content creator 716, and hosting provider 720 are coupled to each other using a network protocol 724 such as TCPIP over the Internet. The client device 704 can be coupled to title manager 712, content publisher 714 and transaction maker 718 using any one of a number of network protocols. Among these are HTTP 706, e-mail (SMTP) 708, and SMS 710.

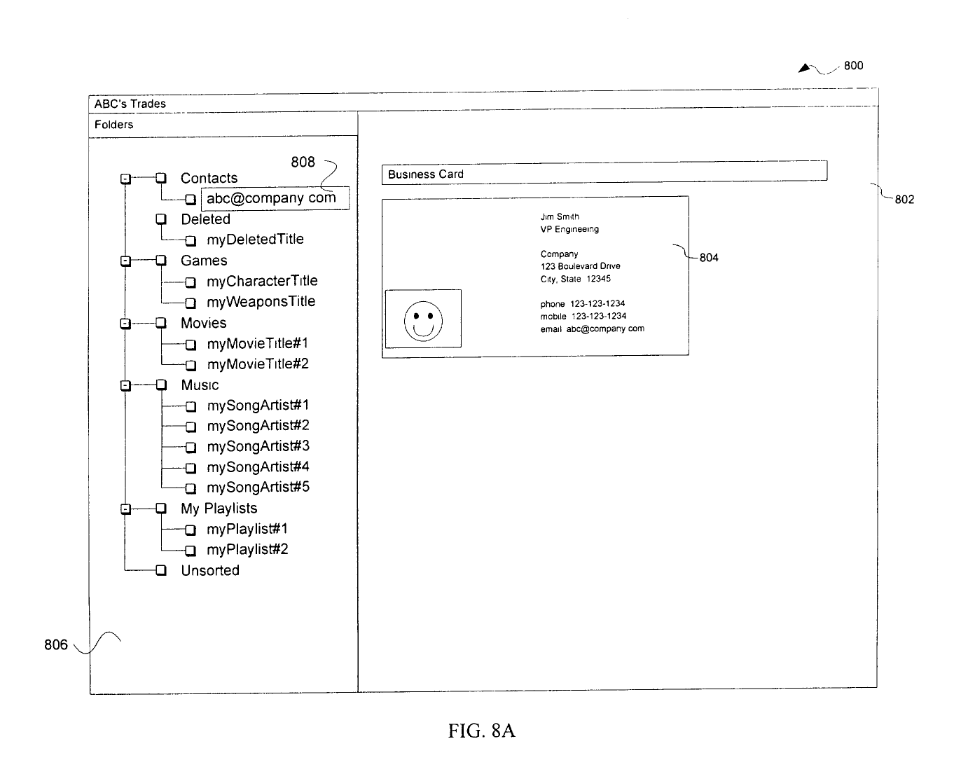

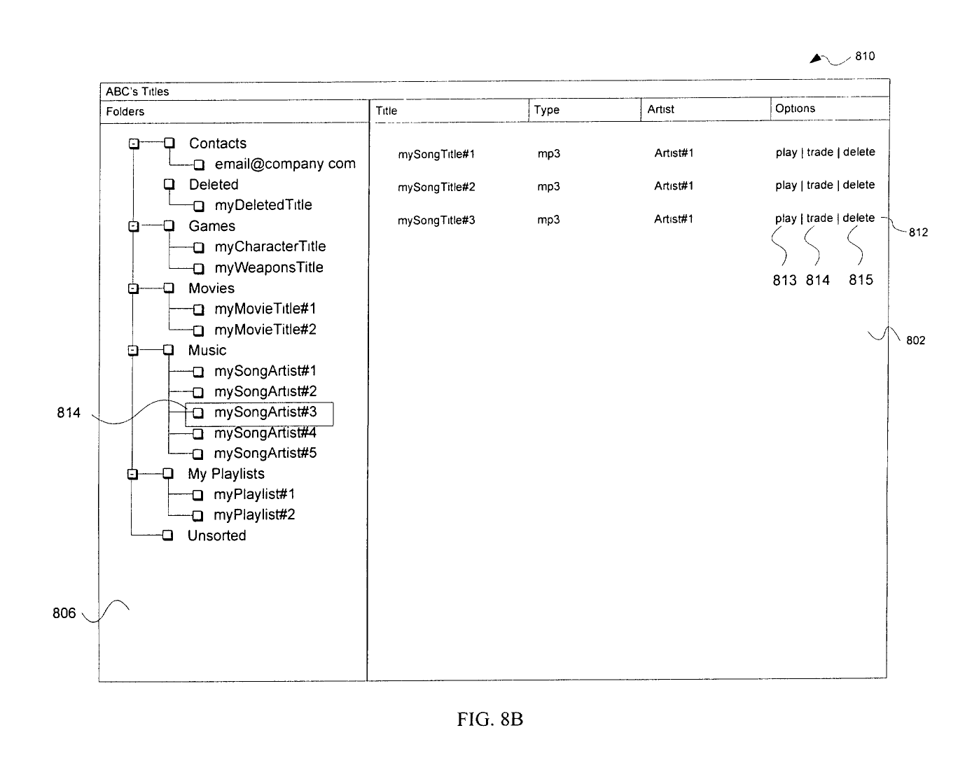

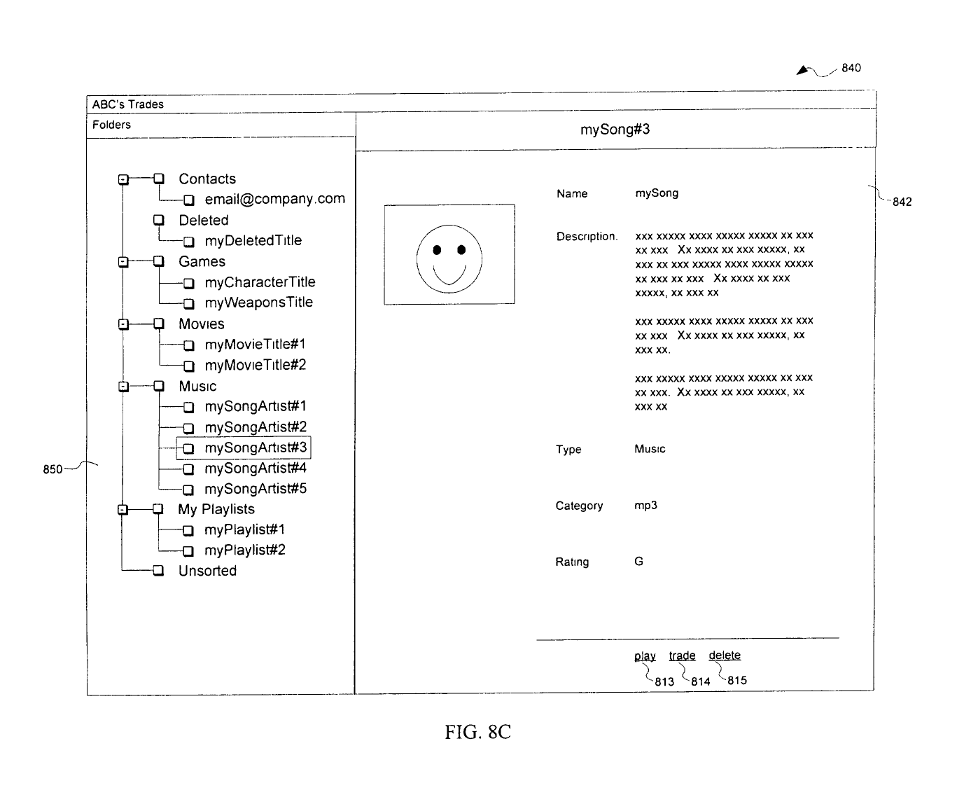

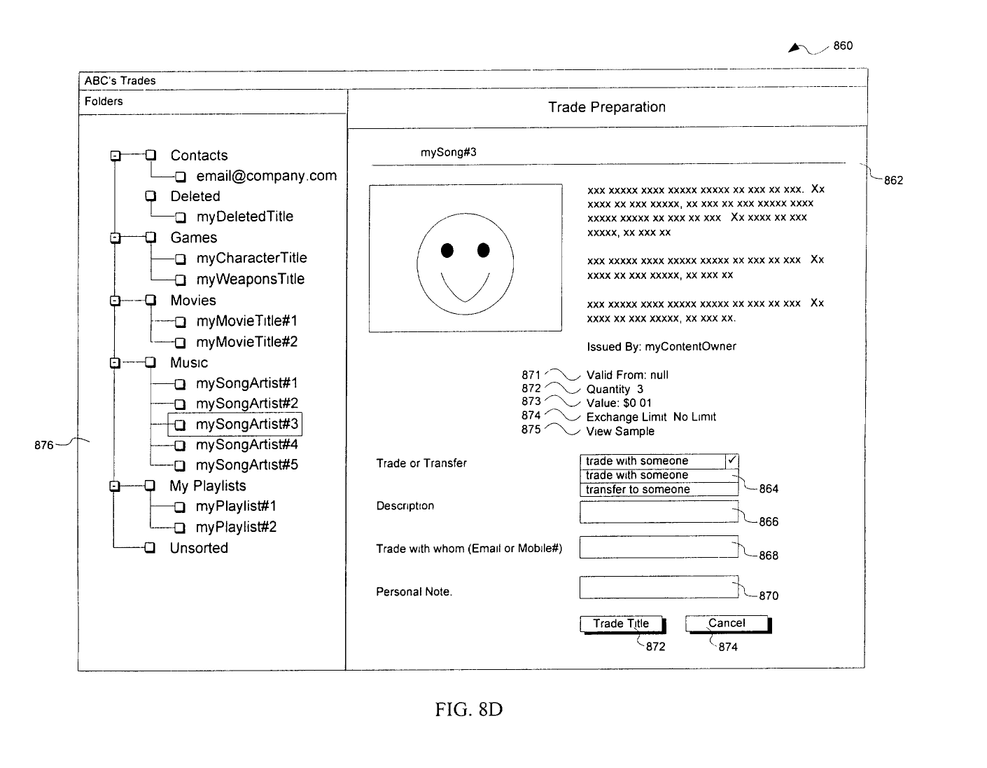

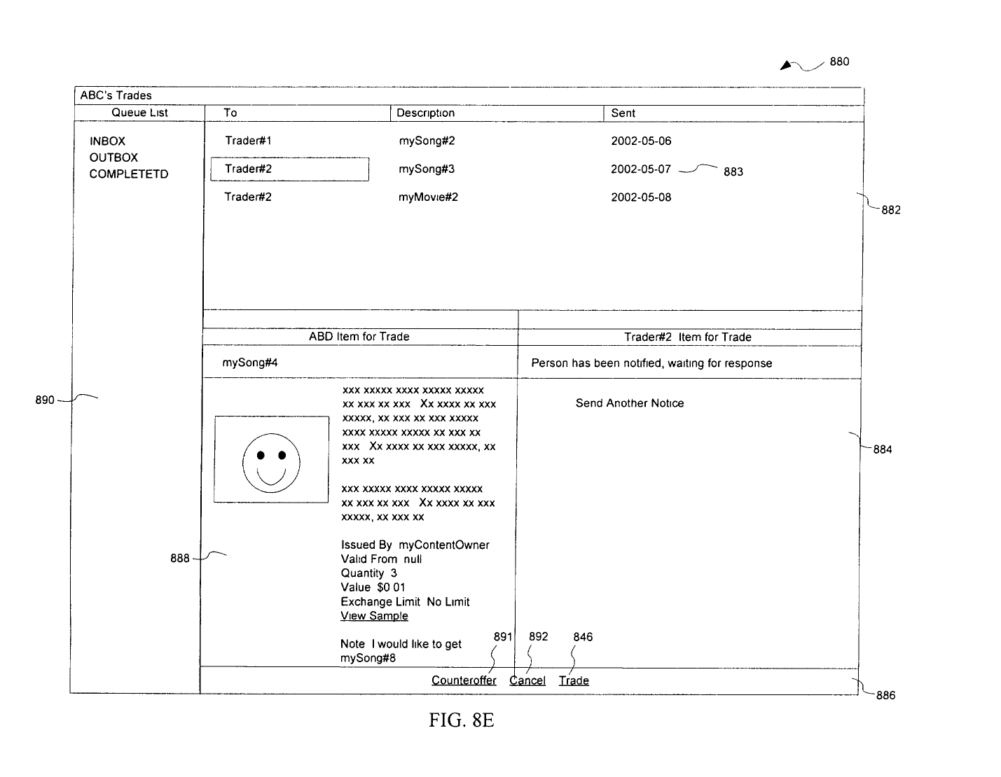

Initially, the content creator 716 creates a digital content file, such as an MP3 song, as well as a title associated with the digital content file. The creating user interacts with a display as shown in FIG. 8A and described in detail below. The digital content file is transmitted across the network protocol 724 to hosting provider 720, where it is stored until a title publisher 714 desires to make it available to users with a client device 704. The content creator also transmits the title to the title manager 712 using network protocol 724.

Users desiring the digital content file will access the transaction maker 718 using the client device 704. Transaction maker 718 functions as a marketplace where digital content buyers and sellers can transact with each other in a secure environment. When a user agrees to buy the digital content file from a seller, in this case the content publisher 714, the transaction maker 718 communicates this to the title manager 712, which in turn, modifies the title of the digital content file with the new rights just purchased by the user. The user can now redeem the digital content file from the content publisher 714 and download it to the client device 704.

If the user desires to transfer the title to a new user, and the title's security indicia allows it, the user can become a digital content seller and post an offer to transfer the title on transaction maker 718. As before, when a new user agrees to buy the digital content file from the user, the transaction maker 718 communicates this to the title manager 712, which in turn, modifies the title of the digital content file with the new rights just purchased by the new user. The buyer can now redeem the digital content file from the title publisher 714 and download it to the client device 704. The seller can no longer access the digital content file on the content publisher 714.

FIG. 8A depicts an exemplary title management screen display 800 according to an embodiment of the invention. This display is used by a user to perform certain functions and access certain data based on their ownerships and permissions, in order to manage, resell, market, barter or auction their respective titles. The display is divided into two sections, a title folder pane 806 and a title content pane 802. The title folder pane 806 can further organize the titles into folders based on different attributes, such as the type of digital content, such as contacts, games, movies, music, play lists, and unsorted. Furthermore, deleted titles are placed a deleted folder. The title content pane 802 displays more detailed information about the digital content. In this example, the user selected title abc@company.com 808 in the title folder pane 806, and is displayed the corresponding business card 804 for a contact “Jim Smith.”

FIG. 8B depicts an exemplary title management screen display 810 according to another embodiment of the invention. As in FIG. 8A, the display is divided into two sections, a title folder pane 806 and a title content pane 802. Each title entry 812 in the title content pane 802 may have a play user selectable button 813, a trade user selectable button 814, and a delete user selectable button 815.

In this example, the user selected mySongArtist#3 814 in the title folder pane 806, and is displayed the owned titles to mySongArtist#3 songs 812. From this display, the user has the option to play 813 the song on the user's client computer, trade 814 the title to the song to another user, or delete 815 the title altogether.

If the user selects one of mySongArtist#3 songs 812, a more detailed title content pane 842 appears, as shown in FIG. 8C. In this pane, a description of the song is displayed, along with the music type, category, and rating. A picture, such as an album cover, can be also displayed. As is FIG. 8B, the user has the option to play 813 the song on the user's client computer, trade 814 the title to the song to another user, or delete 815 the title altogether.

For example, if the user chooses to trade 814 mySong#3, a trade preparation pane 862 appears, as shown in FIG. 8D. Aside from the information that was previously displayed in the title content pane 842 of FIG. 8C, additional information is displayed, such as a valid from date field 871, a quantity field 872, a value field 873, and an exchange limit field 874. The user can also view a sample 875 of mySong#3.

The user must select whether to trade or transfer 864 the title of mySong#3 with another user. Additionally, the user may be asked if they would like to list it on a barter site (“list on barter site”) or post it to a transaction maker site (“post to transaction maker”). The user can enter description of the mySong#3 in the description field 866, as well as a note in the personal note field 870 to the user with whom the trade is being transacted. In the trade with whom field 868, the user enters the e-mail or mobile phone number of the user with whom they wish to trade. Once this information is substantially complete, the user selects the user selectable button trade title 872 to proceed, or the user selectable button cancel 874 to cancel the transaction.

The e-mail and mobile phone numbers are used to provide examples of identifying trading parties. The title transaction system has been designed with a flexible and extensible title format to accept and support a variety of naming schemes, including [but not limited to] domain name, phone numbers, X.500 naming, and LDAP.

FIG. 8E depicts an exemplary title trades screen display 880 according to another embodiment of the invention. This display shows the current status of a user's title transactions. The display is divided into five sections, a title folder pane 890 a title status summary pane 882, a title bid pane 888, and a title offered pane 884, and an action pane with a series of user selectable buttons: counteroffer 891, cancel 892, and trade 846. In this example, the user selected mySong#3 883 was offered to trader#2, who has been notified. Once trader#2 makes an offer for trade, the user can counteroffer 891, cancel 892, or trade 846 and complete the transaction.

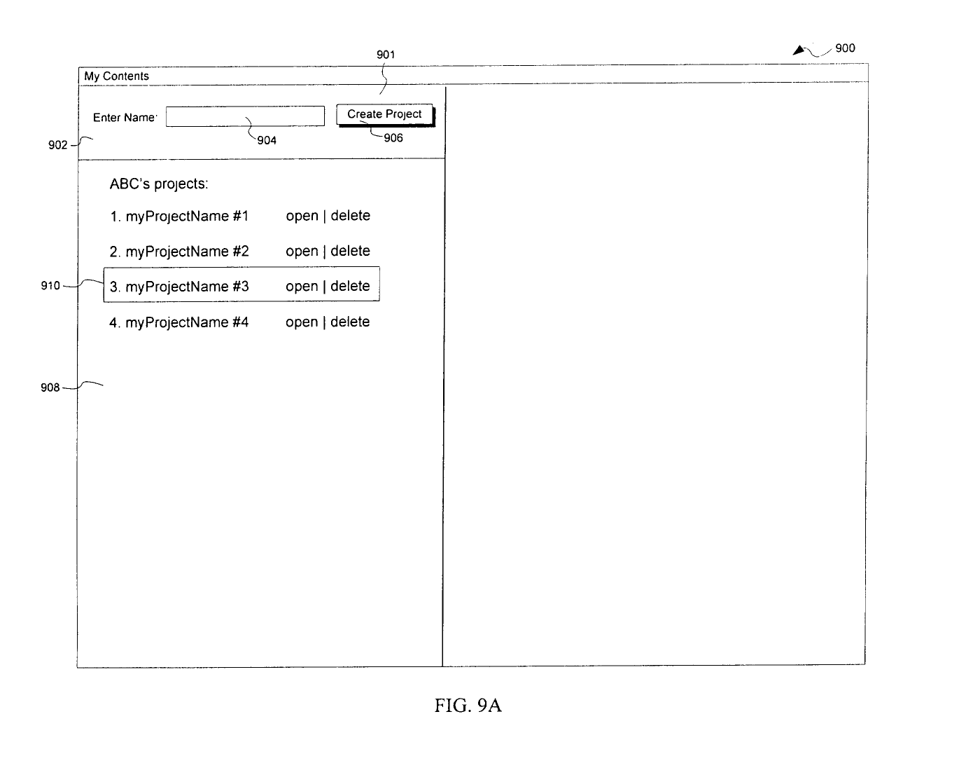

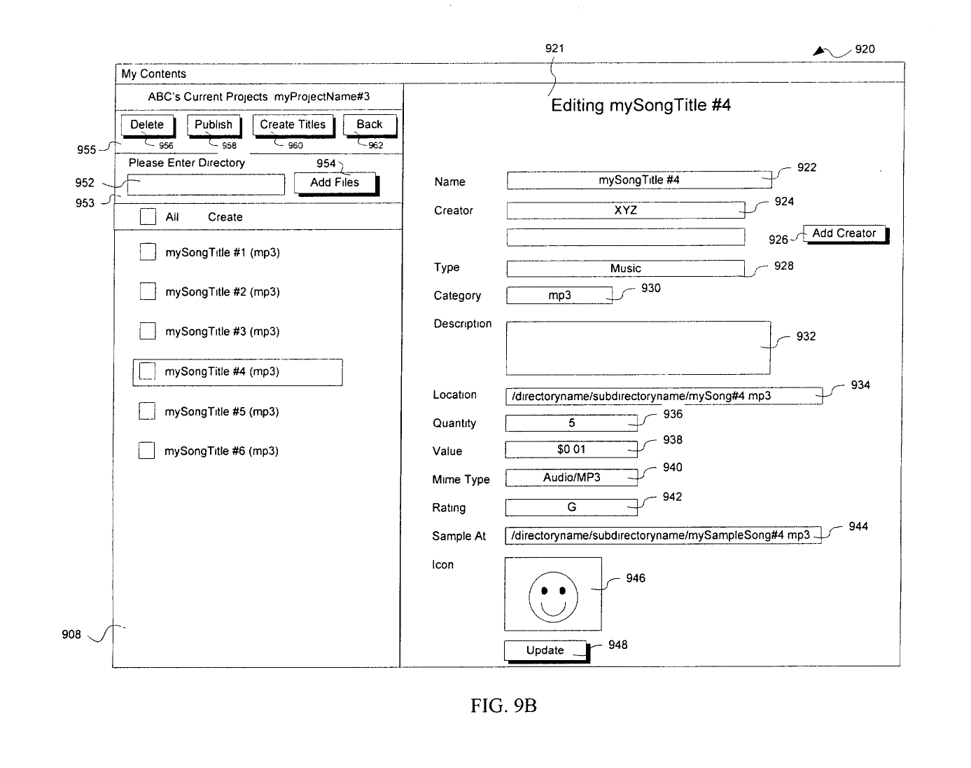

FIG. 9A depicts exemplary title creation screen display 900 according to an embodiment of the invention. The number of digital content files that a title can contain is substantial. Furthermore, the addressing or referencing scheme used by the content element is flexible to support numerous simple and complex structure s such as URL's, object identifiers, domain names, alternate pointers, complex multi-part pointers, and even embedded content. With embedded content, the title actually contains the content and can optionally support a variety of encoding and encryption schemes.

The display is divided into two sections, a new project pane 902, and a project list pane 908. A project is a set of digital content files that share the same title object. If the user opens myProjectName#3, 910 for example, a project detail display 920 appears, as in FIG. 9B.

FIG. 9B depicts an exemplary project detail display 920 according to another embodiment of the invention, in which a song title is edited. The display is divided into four sections. The first is an action pane 955 with a series of user selectable buttons: delete 956, publish 958, create titles 960, and back 962. The second is an add file pane 953 with a user selectable button add files 954, and a field to enter the directory in which the files are stored 952. The third is a project list pane 908. And the fourth is a project detail pane 921.

Digital content files can be quickly added to a project by entering the name of the directory in which they are located into user input field 952, and selecting the add files user selectable button 954. Furthermore, information contained in the title is shown and can be modified through fields the project detail pane 921 such as: name field 922, creator field 924, type field 928, category field 930, description field 932, location field 934, quantity field 936, value field 938, mime type field 940, rating field 942, sample at field 944, and icon field 946. When the users wish to save the information in the title, the user selectable button update 948 is selected.

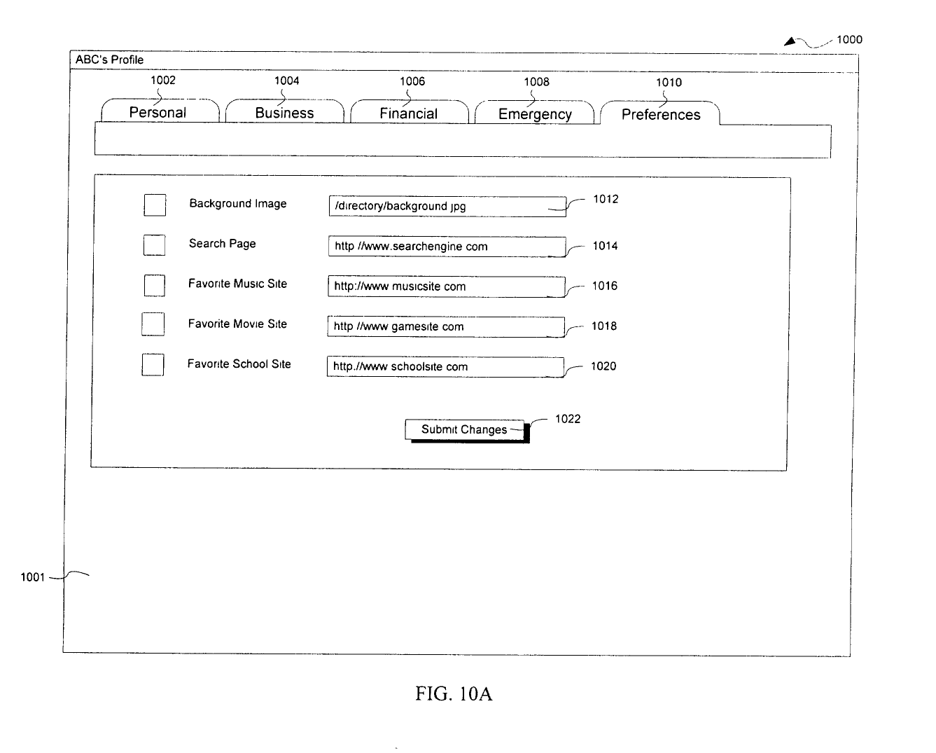

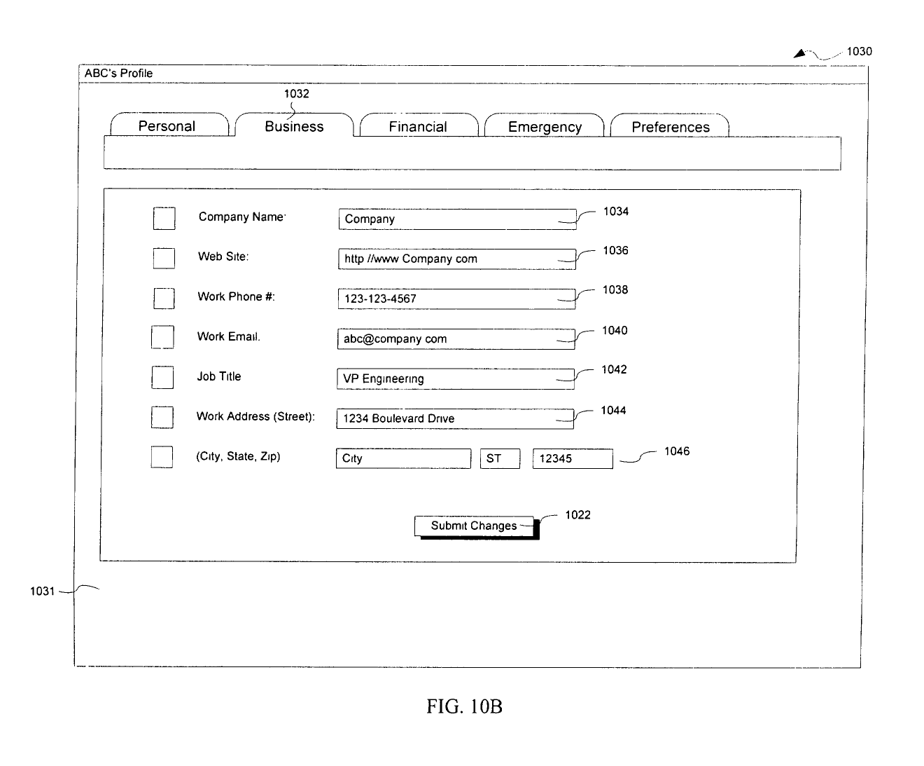

FIG. 10A depicts an exemplary administration screen display 1000 according to another embodiment of the invention. The profile is used to store administrative information about each user, preferences to customize the user interface, and custom rules that the user wants applied. The display is divided into 5 tabs: personal 1002, business 1004, financial 1006, emergency 1008, and preferences 1010. The preferences 1010 tab further contains the following fields: background image 1012, search page 1014, favorite music site 1016, favorite movie site 1018, and favorite school Site 1020. When the users wish to save the information in the profile, the submit changes 1022 button is selected.

The business tab 1032, as shown FIG. 10B, contains the following fields: company name 1034, web site 1036, work phone #1038, work email 1040, job title 1042, and work address 1044-1046. As in FIG. 10A, when the users wish to save the information in the profile, the submit changes 1022 button is selected.

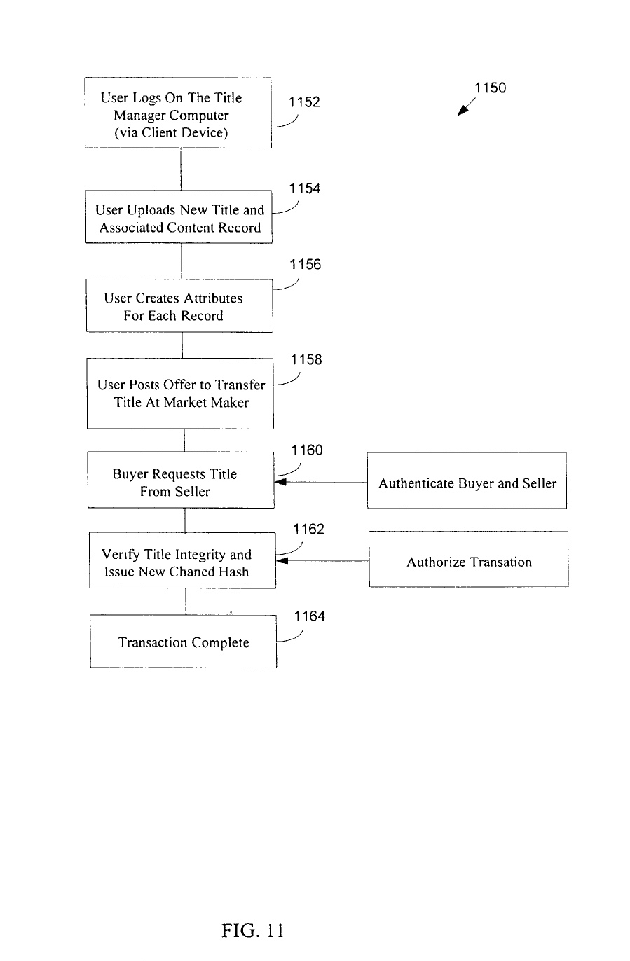

FIG. 11 is a flow chart showing steps for performing a title transfer according to an embodiment of the invention. Initially, the user logs on the title manager computer 1152 and uploads a new title and associated content record 1154. The user then creates attributes for each record 1156. The user then posts an offer to transfer the title on transaction maker 1158. A buyer who desires the digital content file requests the title from the seller 1160, whereby both the buyer and seller are authenticated. The title integrity is verified and a new chained hash is issued 1162, authorizing the transaction. When this is accomplished, the transaction is complete 1164.

C. Conclusion

Advantages of the invention include the ability to easily and efficiently manage and share titles over a network such as the Internet. Additional advantages of the invention include creating a system whereby digital content providers can offload the burden of managing and enforcing user access rights, yet receive revenue from third party transactions.

Having disclosed exemplary embodiments and the best mode, modifications and variations may be made to the disclosed embodiments while remaining within the subject and spirit of the invention as defined by the following claims.

1. A title management apparatus resident on a first computer including a memory for storing a control program and data, and a processor for executing said control program and for managing said data, comprising:
user data resident in said memory including user security indicia;
one or more title objects resident in said memory, where each title object includes a content element, attributes, and security indicia;
an authorization structure configured to selectively redeem said content element based at least in part of said user security indicia; and,
a title management structure configured to associate a first user with particular title objects based at least in part of said user data and said title attributes.

2. The title management apparatus of claim 1, wherein said title object is one of a tag, a ticket, and a token.

3. The title management apparatus of claim 2, wherein said content element is a pointer that is indicative of a digital content file address, further comprising:
a content storage structure including a first storage element for storing a first digital content file;
a title publishing structure including a second storage element for storing said title object;
wherein said title management structure is configured to redeem said title object from said title publishing structure; and,
said title management structure is further configured to redeem said first digital content file that is indicated by said pointer.

4. The title management apparatus of claim 3, wherein:
said content storage structure is resident on a second computer that is communicably connected to said first computer.

5. The title management apparatus of claim 4, wherein:
said title publishing structure is resident on a third computer that is communicably connected to said first computer and said second computer.

6. The title management apparatus of claim 3, wherein said first digital content file is a compilation of one or more additional digital content files.

7. The title management apparatus of claim 3, wherein said first digital content file is a compilation of one or more title objects.

8. The title management apparatus of claim 3, wherein said first digital content file is a compilation of at least one additional digital content file and at least one title object.

9. The title management apparatus of claim 1, wherein said security indicia includes an authorization of a second user.

10. The title management apparatus of claim 3, further comprising:
a transaction maker structure configured to store title objects, offered for one of sale and exchange, by one or more users; and,
said transaction maker structure is configured to transfer title ownership from said first user to a second user.

11. The title management apparatus of claim 5, further comprising:
a transaction maker structure configured to store title objects, offered for one of sale and exchange, by one or more users;
said transaction maker structure is configured to transfer title ownership from said first user to a second user; and,
said transaction maker structure is resident on a fourth computer that is communicably connected to said first computer, said second computer, and said third computer.

12. The title management apparatus of claim 10, wherein:
said title management structure is configured to notify said second user of said sale.

13. The title management apparatus of claim 12, wherein:
said title management structure is further configured to require an acceptance by said second user.

14. The title management apparatus of claim 12, wherein:
said title management structure is further configured to allow said second user to propose a counter-offer.

15. The title management apparatus of claim 10, wherein:
said title management structure is configured to notify said second user of said exchange.

16. The title management apparatus of claim 15, wherein:
said title management structure is further configured to require an acceptance by said second user.

17. The title management apparatus of claim 15, wherein:
said title management structure is further configured to allow said second user to propose a counter-offer.

18. The title management apparatus of claim 10, wherein:
said memory includes a chained hash control program; and
said title management structure is configured to execute said chained hash control program when said title object is transferred between said first user and said second user thereby creating a new security indicia, and to modify said title object security indicia to store said new security indicia.

19. The title management apparatus of claim 10, further comprising:
a lock box structure configured to store said title object during said transfer.

20. The title management apparatus of claim 11, further comprising:
a lock box structure configured to store said title object during said transfer; and,
said lock box structure is resident on a fifth computer that is communicably connected to said first computer, said second computer, said third computer, and said fourth computer.

21. A method of managing title objects in a first computer having a memory, comprising the steps of:
storing in the memory a plurality of title objects each including a content element, attributes and security indicia, where the content element includes a set of digital content files, attributes include a file name, creation date, creator and owner, and security indicia includes a chained hash key;
a first user logging into the computer;
selectively associating the title objects with the first user based at least in part of the user security indicia; and
allowing the exchange of title objects between the first user and a second user based at least in part of the user security indicia.

22. The method of claim 21, wherein said content element further includes a set of additional title objects.

23. The method of claim 21, wherein said title object is one of a tag, a ticket, and a token.

24. The method of claim 21, wherein the content element is a pointer that is indicative of a digital content file address, wherein the step of allowing the exchange of title objects further comprising:
storing a first digital content file in a content storage structure;
creating said title object in a title publishing structure;
redeeming said title object from said title publishing structure; and,
thereafter redeeming said first digital content file that is indicated by said pointer.

25. The method of claim 24 wherein the step of allowing the exchange of title objects further includes:
notifying said second user.

26. The method of claim 25 wherein the step of allowing the exchange of title objects further includes:
receiving an acceptance from said second user.

27. The method of claim 25, further including the step of:
receiving a counter-offer from said second user.

28. The method of claim 21, wherein the content element is a pointer that is indicative of a digital content file address, wherein the step of allowing the exchange of title objects further comprises:
storing a first digital content file in a content storage structure;
creating said title object in a title publishing structure;
storing said title object in a transaction maker structure;
redeeming said title object from said transaction maker structure; and,
thereafter redeeming said first digital content file that is indicated by said pointer.

29. The method of claim 28, wherein the step of redeeming said title object from said transaction maker structure further includes:
purchasing said first title object.

30. The method of claim 28, wherein the step of redeeming said title object from said transaction maker structure further includes:
exchanging said first title object with a second title object.

31. The method of claim 21, wherein:
the step of allowing the exchange of title objects includes the step of storing said title object in a lock box structure during said exchange.
